(19) United States
(12) Patent Application Publication
(10) Pub. No.: US 2020/0069030 A1
(43) Pub. Date: Mar. 5, 2020

(54) MULTI-PENCIL TYPE COSMETIC CONTAINER

(71) Applicant: C&C INTERNATIONAL CO., LTD., Gyeonggi-do (KR)

(72) Inventor: Eun-chul BAE, Gyeonggi-do (KR)

(73) Assignee: C&C INTERNATIONAL CO., LTD., Gyeonggi-do (KR)

(21) Appl. No.: 16/554,854

(22) Filed: Aug. 29, 2019

(30) Foreign Application Priority Data
Sep. 3, 2018 (KR) 10-2018-0104680

(51) Int. Cl. A45D 40/20; B43K 21/00; B43K 21/08; B43K 21/22

(52) U.S. Cl. CPC A45D 40/205; B43K 21/006; A45D 2040/208; B43K 21/22; A45D 2200/1072; B43K 21/085

(57) ABSTRACT

The present invention relates to a multi-pencil type cosmetic container, in which a holder, to which a plurality of pencil leads are coupled, moves up or down by the rotation operation of a body and thus the plurality of leads are simultaneously move in or out so as to be used, wherein assembly parts are simplified while improving manufacturing productivity and economic efficiency, and the plurality of pencil leads can be mixed in a variety of different colors or formulations, thereby allowing easier and more various makeup.

### CROSS REFERENCE TO PRIOR APPLICATIONS

The present application claims priority under 35 U.S.C. §119 to Korean Patent Application No. 10-2018-0104680 (filed on Sep. 3, 2018).

### BACKGROUND

### Field of the Invention

The present invention relates to a multi-pencil type cosmetic container and, more specifically, to a multi-pencil type cosmetic container, in which a holder, to which a plurality of pencil leads are coupled, moves up or down by the rotation operation of a body and thus the plurality of leads are simultaneously move in or out so as to be used, wherein assembly parts are simplified while improving manufacturing productivity and economic efficiency, and the plurality of pencil leads can be mixed in a variety of different colors or formulations, thereby allowing easier and more various makeup.

### Background Art

Generally, a pencil type cosmetic container uses a pencil-shaped lead to move in or out of a container, such as a lip liner, a brow pencil, and an eyeliner.

Such conventional pencil type cosmetic containers have been disclosed in a variety of structures, wherein mainly a holder for coupling a cosmetic lead is coupled to the inside of a body and the holder is spirally coupled to a rotator such that the pencil can be used by rotating the rotator so as to move the holder back and forth.

However, the conventional pencil type cosmetic container described above have problems in that the wear rate of the pencil lead is fast due to the use of a single pencil lead provided to move in and out and thus only one color can be provided, thereby degrading economic efficiency and makeup efficiency.

In addition, the conventional pencil type cosmetic container described above has further problems in that since the degree of make-up varies depending on the thickness of the pencil lead, for example, a pencil lead of a thick cross section is drawn wide and thick and a pencil lead of a thin cross section has to be repetitively used several times, it takes a long time to make up and it is difficult to express makeup with diversity.

In particular, since it is not possible to use makeup leads of different colors or formulations at the same time, there was a limit in more simple and various makeup.

### PRIOR ART DOCUMENTS

### Patent Documents

(Patent Document 1) Korean Utility Model Reg. No. 20-0202796

(Patent Document 2) Korean Patent Reg. No. 10-1440576

### SUMMARY

### Technical Problem

The present invention has been derived to solve the above-mentioned problems of the prior art and has an objective to move a holder, to which pencil leads are coupled, up and down by the rotation operation of a body so as to use the pencil leads while simplifying assembly parts and improving manufacturing productivity and economic efficiency.

In particular, the present invention has an objective to allow easier and more various makeup by coupling a plurality of, that is, two or three or more pencil leads to the holder so as to be simultaneously moved in or out and thus used and enabling different colors or formulations mixed in various ways.

### Technical Solution

To accomplish the above objectives, the present invention provides a multi-pencil type cosmetic container, comprising: a body having a cylindrical cross-sectional structure and including a stepped assembly groove part and a stepped coupling part respectively formed on the inside and the outside of the upper portion thereof; an upper cap, into which the upper portion of the body is inserted and which is coupled to the stepped coupling part outside the upper portion of the body; a shoulder coupled by inserting a stepped assembly part at the lower portion thereof into the stepped assembly groove part of the body such that the shoulder and the body can rotate with respect to each other while being prevented from separation; a rotating operation body including an upper rod member and a lower rotation part having grooves formed at regular angles on the outer circumference thereof, wherein the lower rotation part carries out rotation operation together with the body by being coupled to a rotating operation part, which is formed at the lower portion of the stepped assembly groove part of the body and has protrusions formed at regular angles on the inner circumference thereof so as to be inserted into the grooves; and a holder including a screw shaft formed at the lower portion thereof and a dish part formed at the upper portion thereof and having a plurality of, that is, at least two or more lead grooves formed such that pencil leads are inserted thereinto, wherein the screw shaft is spirally coupled to a spiral part on the inside of the upper rod member of the rotating operation body and the dish part is inserted into the shoulder so as to move up and down such that a plurality of leads can be used while being moved in or out simultaneously.

According to the present invention, upper and lower insertion hole parts are formed stepwise on the inside of the shoulder so that the dish part of the holder is inserted into the upper insertion hole part so as to be guided up and down and the upper rod member of the rotating operation body is inserted into and coupled to the lower insertion hole part, the upper insertion hole part has a holding protrusion formed at the upper portion so as to prevent the separation of the dish part and lead exit holes formed corresponding to the lead grooves of the dish part, and the lower insertion hole part has a coupling groove, which is engaged with the stepped outer circumference of the coupling part and a ring-shaped coupling protrusion formed on the lower portion of the upper rod member so as to be rotatably coupled while being prevented from separation.

According to the present invention, the dish part of the holder and the upper insertion hole part of the shoulder, into which the dish part is inserted, are formed in a rectangular cross-sectional structure so that the shoulder is guided up and down.

According to the present invention, inclination guide parts are provided facing each other at both sides between the upper and lower insertion hole parts of the shoulder so as to guide the insertion of the dish part of the holder into the upper insertion hole part.

According to the present invention, the upper rod member of the rotating operation body includes a support protrusion formed protruding from the outside of the upper portion thereof so as to support the upper rod member without lateral movement in the lower insertion hole part.

According to the present invention, the pencil leads coupled to the lead grooves of the dish part are formed to be different from each other in one or more items of cross-sectional size, shape or color.

### Effect of the Invention

According to the present invention, the shoulder is coupled to the stepped assembly groove part on the inside of the body at the upper portion of the body so as to rotate with respect to each other while being prevented from separating, the rotating operation body is inserted into the lower portion of the shoulder such that the outside of the lower portion of the rotating operation body and the inner circumference of the body are engaged with each other in a concave and convex structure and thus the rotating operation body and the shoulder are coupled to carry out rotation operation together, and the screw shaft at the lower portion of the holder is spirally coupled to the inside of the rotating operation body and the plurality of, that is, at least two or more pencil leads are coupled to the dish part at the upper portion of the holder such that the dish part of the holder moves up or down in the shoulder by the rotation operation of the body and thus the plurality of leads are simultaneously move in or out so as to be used, wherein assembly parts are simplified thereby improving manufacturing productivity and economic efficiency.

In particular, the plurality of, that is, two or three or more pencil leads are coupled to the holder so as to be simultaneously moved in or out and thus used, thereby enabling different colors or formulations to be mixed in various ways.

For example, the plurality of, that is, two or three or more pencil leads can be used in combination of different colors and formulations for natural color expression, makeup can be carried out easily by means of the plurality of pencil leads without several repetition, colors and formulations can be used in combination with diversity, and simple and versatile makeup can be realized with thin or thick lines according to the directions of the pencil leads.

### BRIEF DESCRIPTION OF THE DRAWINGS

FIG. 1 is a perspective view showing the appearance of the present invention pencil.

FIG. 2 is a perspective view showing an upper cap in FIG. 1 in a separate state.

FIG. 3 is an exploded perspective view showing a shoulder, a rotating operation body, and a holder in FIG. 2

FIG. 4 is a perspective view showing the cross-section of the parts, shown in FIG. 3, in an assembled state.

FIG. 5 is an exploded perspective view of FIG. 4.

FIG. 6 is a perspective view showing the cross-section of the parts, shown in FIG. 4, cut in another direction.

FIG. 7 is a cross-sectional view of the present invention pencil in an assembled state.

FIG. 8 is a cross-sectional view according to line A-A in FIG. 7.

FIG. 9 is a cross-sectional view according to line B-B in FIG. 7, and

FIG. 10 is a cross-sectional view showing the operating state of the present invention.

### DETAILED DESCRIPTION OF EMBODIMENTS

Hereinafter, the preferred embodiments of the present invention will now be described in detail with reference to the accompanying drawings.

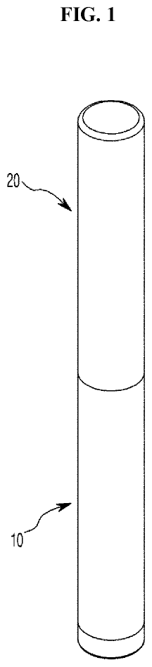

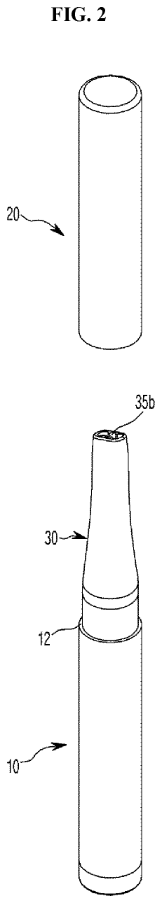

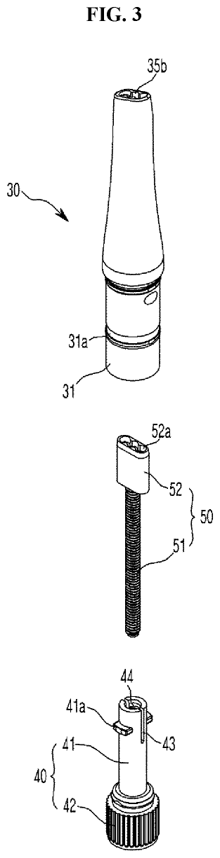

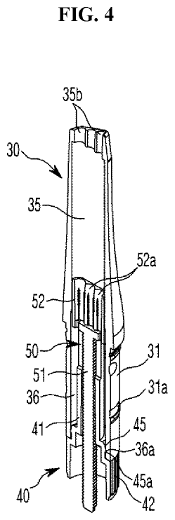

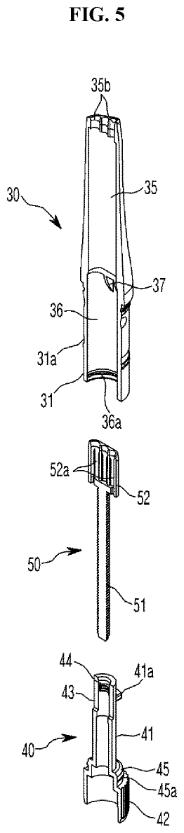

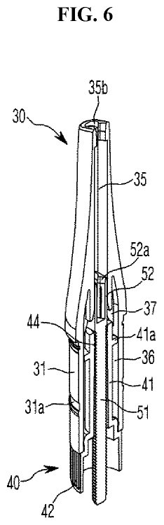

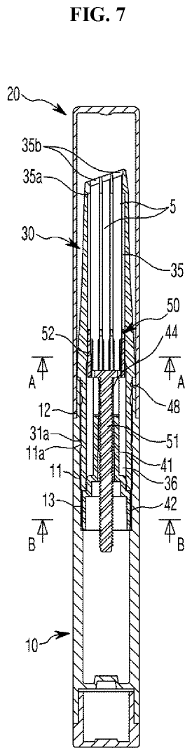

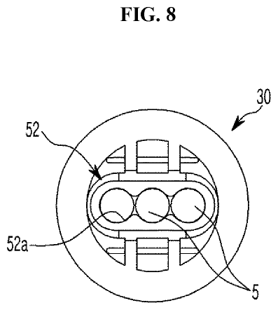

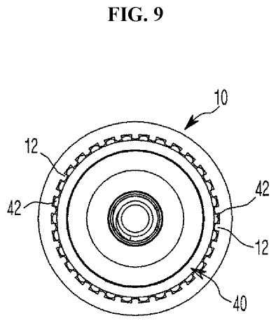

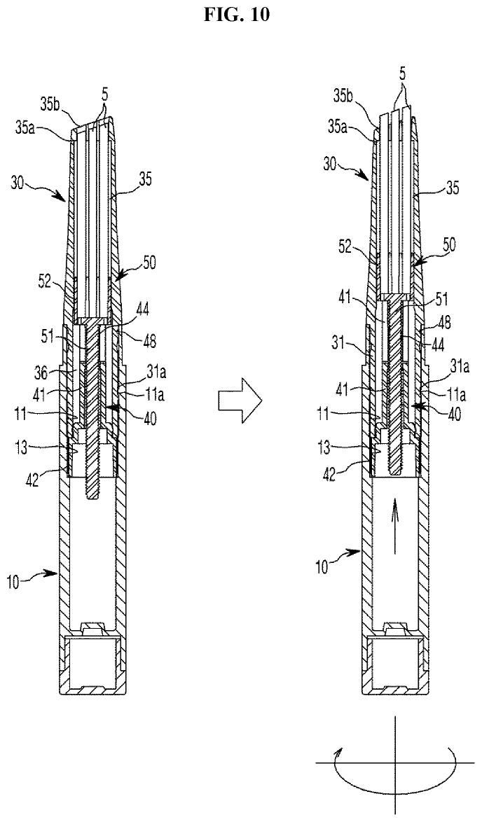

A multi-pencil type cosmetic container according to the present invention includes a body 10, an upper cap 20, a shoulder 30, a rotating operation body 40, and a holder 50, as shown in FIG. 1 to FIG. 10.

The body 10 has a cylindrical cross-sectional structure and includes a stepped assembly groove part 11 and a stepped coupling part 12 respectively formed on the inside and the outside of the upper portion thereof.

The upper cap 20 is formed such that the upper portion of the body 10 is inserted into the same so as to be fixed and coupled thereto.

The shoulder 30 has a stepped assembly part 31 formed at the lower portion thereof and inserted into and coupled to the stepped assembly groove part 11 of the body 10 such that a ring-shaped coupling protrusion 11a and a coupling groove 31a are coupled to each other and rotate each other while being prevented from separation.

The rotating operation body 40 includes an upper rod member 41 and a lower rotation part 42 having grooves formed at regular angles on the outer circumference thereof, wherein the lower rotation part 42 carries out rotation operation together with the body 10 by being coupled to a rotating operation part 13, which is formed at the lower portion of the stepped assembly groove part 11 of the body 10 and has protrusions formed at regular angles on the inner circumference thereof so as to be inserted into the grooves.

The holder 50 includes a screw shaft 51 formed at the lower portion thereof and a dish part 52 formed at the upper portion thereof and having a plurality of, that is, at least two or more lead grooves 52a formed such that pencil leads 5 are inserted thereinto, wherein the screw shaft 51 is inserted into and coupled to the upper rod member 41 of the rotating operation body 40.

Herein, the upper rod member 41 of the rotating operation body 40 can be opened inwards and outwards by an incision groove 43, which are cut vertically on the circumference thereof, and has a spiral part 44, to which the screw shaft 51 is spirally coupled.

In addition, upper and lower insertion hole parts 35 and 36 are formed stepwise on the inside of the shoulder 30 so that the dish part 52 of the holder 50 is inserted into the upper insertion hole part 35 so as to be guided up and down and the upper rod member 41 of the rotating operation body 40 is inserted into and coupled to the lower insertion hole part 36.

Furthermore, the upper insertion hole part 35 has a holding protrusion 35a formed at the upper portion so as to prevent the separation of the dish part 52 and lead exit holes 35b formed corresponding to the lead grooves 52a of the dish part 52, and the lower insertion hole part 36 has a coupling groove 36a, which is engaged with the stepped outer circumference of the coupling part 45 and a ring-shaped coupling protrusion 45a formed on the lower portion of the upper rod member 41 so as to be rotatably coupled while being prevented from separation.

In addition, the upper insertion hole part 36 of the shoulder 30, into which the dish part 52 of the holder 50 is inserted, is formed in a rectangular cross-sectional structure so as to guide the up and down movement of the dish part 52 of the holder 50 while preventing the rotation of the holder 50.

Meanwhile, inclination guide parts 37 are provided facing each other at both sides between the upper and lower insertion hole parts 35, 36 of the shoulder 30 so as to guide the insertion of the dish part 52 of the holder 50 into the upper insertion hole part 35.

That is, side surface bodies forming the rectangular shape of the dish part 52 are guided along the inclination guide part 37 and smoothly guided and inserted into the upper insertion hole part 35.

The upper rod member 41 of the rotating operation body 40 includes a support protrusion 41a, which is formed protruding from the outside of the upper portion thereof so as to support the upper rod member 41 without lateral movement in the lower insertion hole part 36.

Furthermore, the pencil leads 5 coupled to the lead grooves 52a of the dish part 52 are formed in colors or formulations different from each other and the plurality of pencil leads 5 are formed to be moved inwards or outwards simultaneously so as to express makeup with diversity more easily.

In particular, the number, cross-sectional shape, etc. of the pencil leads 5 can be variously applied by replacing the shoulder 30 and the holder 50

Reference numeral 48, which is not explained hereinabove, denotes a sealing ring.

Now, the operations and effects of the present invention configured above will be explained in detail.

First, the screw shaft 51 at the lower portion of the holder 50 is inserted into the upper rod member 41 of the rotating operation body 40.

Herein, the upper rod member 41 is opened inwards or outwards by the incision groove 43 formed vertically in the circumference such that the screw shaft 51 at the lower portion of the holder is simply inserted and the screw shaft 51 is assembled to be spirally coupled to the spiral part 44 on the inside of the upper rod member 41.

In this state, the upper rod member 41 of the rotating operation body 40 is assembled by being inserted into the lower insertion hole part 36 at the lower portion inside the shoulder 30.

Herein, the lower insertion hole part 36 of the shoulder 30 is coupled, with the coupling groove 36a, to the stepped outer circumference of the coupling part 45 and the ring-shaped coupling protrusion 45a formed at the lower portion of the upper rod member 41 so as to be rotatably coupled while being prevented from separation.

In addition, the dish part 52 of the holder 50 coupled to the upper portion of the rotating operation body 40 is formed in a rectangular shape and inserted into the upper insertion hole part 35 of the shoulder 30, wherein the inclination guide parts 37 are formed between the upper and lower insertion hole parts 35, 36 of the shoulder 30 and the side surface bodies forming the rectangular shape in the dish part 52 of the holder are inserted to be guided such that the dish part is smoothly inserted into the upper insertion hole part 35 of the shoulder 30.

In this simple assembled state, the dish part 52 of the holder 50 is moved up such that the pencil leads 5 are inserted into and coupled to the plurality of lead grooves 52a formed on the dish part 52 through the lead exit hole 35b at the upper portion of the shoulder 30.

Herein, the plurality of pencil leads 5 can be formed in colors or formulations different from each other and used in a variety of assembly.

In the case of using the container of the present invention assembled as described above, the body 10 and the shoulder 30 are held and the body 10 is rotated and adjusted while the upper cap 20 is opened.

By the rotation adjustment of the body 10, the protrusions formed at regular angles on the outside of the lower rotation part 42 of the rotating operation body 40 are coupled to be engaged with the rotation operation part 13 formed on the inner circumference of the stepped assembly groove part 11 of the body 10 at the lower portion thereof such that the rotating operation body 40 rotates together with the body 10.

At this time, since the support protrusions 41a on the outside of the upper rod member 41 of the rotating operation body 40 at the upper portion thereof are supported on the inner wall surface of the lower insertion hole part 36 of the shoulder 30, the upper rod member 41 of the rotating operation body 40 rotates constantly without lateral movement

As described above, the screw shaft 51 at the lower portion of the holder 50 spirally coupled to the spiral part 44 of the rotating operation body 40 is controlled in the up and down movement by the rotation of the rotating operation body 40 and the dish part 52 at the upper portion of the screw shaft 51 moves up and down in the upper insertion hole part 35 of the shoulder 30, such that the cosmetic leads 5 can be controlled to be moved inwards or outwards through the upper portion of the shoulder 30.

In particular, the plurality of, that is, two or three or more pencil leads 5 are coupled to the dish part 52 of the holder 50 so as to be simultaneously moved inwards or outwards for use through the lead exit hole 35b in the upper portion of the shoulder 30.

That is, makeup can be carried out easily owing to the plurality of pencil leads 5 without several repetition, the plurality of pencil leads 5 can be formed in colors and formulations different from each other so as to be used in combination of the colors and formulations different from each other for natural color expression, and simple and versatile makeup can be realized with thin or thick lines according to the directions of the pencil leads.

### BRIEF EXPLANATION OF REFERENCE NUMERALS

5: Pencil lead

10: Body

11: Stepped assembly groove part

12: Stepped coupling part

13: Rotating operation part

20: Upper cap

30: Shoulder

31: Stepped assembly part

35, 36: upper and lower insertion hole parts

35a: Holding protrusion

35b: Lead exit hole

36a: Coupling groove

37: Inclination guide part

40: Rotating operation body

41: Upper rod member

41a: Support protrusion

42: Lower rotation part

44: Spiral part

45: Coupling part

45a: Coupling protrusion

50: Holder

51: Screw shaft

52: Dish part

52a: Lead groove

What is claimed is:

1. A multi-pencil type cosmetic container, comprising:
a body having a cylindrical cross-sectional structure and including a stepped assembly groove part and a stepped coupling part respectively formed on the inside and the outside of the upper portion thereof;
an upper cap, into which the upper portion of the body is inserted and which is coupled to the stepped coupling part outside the upper portion of the body;
an upper cap, into which the upper portion of the body is inserted and which is coupled to the stepped coupling part outside the upper portion of the body;
a shoulder coupled by inserting a stepped assembly part at the lower portion thereof into the stepped assembly groove part of the body such that the shoulder and the body can rotate with respect to each other while being prevented from separation;
a rotating operation body including an upper rod member and a lower rotation part having grooves formed at regular angles on the outer circumference thereof, wherein the lower rotation part carries out rotation operation together with the body by being coupled to a rotating operation part, which is formed at the lower portion of the stepped assembly groove part of the body and has protrusions formed at regular angles on the inner circumference thereof so as to be inserted into the grooves; and
a holder including a screw shaft formed at the lower portion thereof and a dish part formed at the upper portion thereof and having a plurality of, that is, at least two or more lead grooves formed such that pencil leads are inserted thereinto, wherein the screw shaft is spirally coupled to a spiral part on the inside of the upper rod member of the rotating operation body and the dish part is inserted into the shoulder so as to move up and down such that a plurality of leads can be used while being moved in or out simultaneously.

2. A multi-pencil type cosmetic container according to claim 1, wherein upper and lower insertion hole parts are formed stepwise on the inside of the shoulder so that the dish part of the holder is inserted into the upper insertion hole part so as to be guided up and down and the upper rod member of the rotating operation body is inserted into and coupled to the lower insertion hole part, the upper insertion hole part has a holding protrusion formed at the upper portion so as to prevent the separation of the dish part and lead exit holes formed corresponding to the lead grooves of the dish part, and the lower insertion hole part has a coupling groove, which is engaged with the stepped outer circumference of the coupling part and a ring-shaped coupling protrusion formed on the lower portion of the upper rod member so as to be rotatably coupled while being prevented from separation.

3. A multi-pencil type cosmetic container according to claim 1, wherein the dish part of the holder and the upper insertion hole part of the shoulder, into which the dish part is inserted, are formed in a rectangular cross-sectional structure so that the shoulder is guided up and down.

4. A multi-pencil type cosmetic container according to claim 1, wherein inclination guide parts are provided facing each other at both sides between the upper and lower insertion hole parts of the shoulder so as to guide the insertion of the dish part of the holder into the upper insertion hole part, and the upper rod member of the rotating operation body includes a support protrusion formed protruding from the outside of the upper portion thereof so as to support the upper rod member without lateral movement in the lower insertion hole part.

5. A multi-pencil type cosmetic container according to claim 1, wherein the pencil leads coupled to the lead grooves of the dish part are formed in colors or formulations different from each other.
